(19) United States
(12) Patent Application Publication
(10) Pub. No.: US 2026/0186566 A1
(43) Pub. Date: Jul. 2, 2026

(54) SYSTEM AND METHOD FOR ESTIMATING ON-SCREEN GAZE POSITION THROUGH MOBILE EYE TRACKING

(71) Applicant: INTHETECH Inc., Daegu (KR)

(72) Inventor: Seung Ho CHOUN, Daegu (KR)

(21) Appl. No.: 19/433,984

(22) Filed: Dec. 29, 2025

(30) Foreign Application Priority Data
Dec. 30, 2024 (KR) 10-2024-0199545

(51) Int. Cl. G06F 3/01

(52) U.S. Cl. CPC G06F 3/013

(57) ABSTRACT

System and method for estimating an on-screen gaze position through mobile eye tracking are disclosed. According to one aspect of the present invention, a computer program stored on a computer-readable medium is provided for performing a method for estimating an on-screen gaze position through mobile eye tracking, wherein the computer program causes a computer to perform the steps of: acquiring a first camera input image capturing a face of a user gazing at a screen of a mobile terminal on which content is being executed; generating a first eye-cropped image by cropping an eye region from the first camera input image; extracting a pupil from the first eye-cropped image and estimating a first relative position; and converting the first relative position into screen coordinates related to the screen using a screen coordinate reference value.

### CROSS-REFERENCE TO RELATED APPLICATION

The present application claims priority under 35 U.S.C. § 119(a) to Korean application number 10-2024-0199545, filed on Dec. 30, 2024, in the Korean Intellectual Property Office, which is incorporated herein by reference in its entirety.

### STATEMENT REGARDING FEDERALLY SPONSORED RESEARCH OR DEVELOPMENT

This work was supported by the National IT Industry Promotion Agency (NIPA), an agency under the MSIT and with the support of the Daegu Digital Innovation Promotion Agency (DIP), the organization under the Daegu Metropolitan Government.

### BACKGROUND

The present invention relates to a system and method for estimating on-screen gaze position through mobile eye tracking.

Recently, the number of Attention-Deficit/Hyperactivity Disorder (ADHD) patients in Korea has been showing a rapid increase, and the increase is particularly noticeable among children and adolescents. ADHD has a critical golden time in which early treatment is essential. Therefore, when the number of pediatric and adolescent patients increases, appropriate treatment must be provided. However, many patients who have had ADHD since childhood often reach adulthood without having received proper treatment.

If ADHD is detected early, learning and social problems can be prevented. If ADHD is not properly managed, there is a high likelihood of learning difficulties, low academic achievement, and social relationship issues. Therefore, therapeutic approaches upon early detection (e.g., behavioral therapy, pharmacological treatment) have a positive impact on the child's development.

Therefore, there is a high need for early diagnosis of ADHD, and technology for this is required.

Recent studies have been conducted to evaluate visual attention and thereby diagnose ADHD, and this requires the collection and analysis of quantitative eye tracking data. However, a limitation exists in that a separate eye-tracker device is necessary to achieve this.

The matters described in the background are intended solely to aid in the understanding of the background of the invention and are not necessarily to be construed as prior art already known to those skilled in the art.

### SUMMARY

The present invention is intended to provide a system and method for estimating an on-screen gaze position through mobile eye tracking, which can extract eyes from an image of a user's face captured using a camera of a mobile terminal and estimate the on-screen gaze position viewed by the user based on the movement of the pupils.

The present invention is intended to provide a system and method for estimating an on-screen gaze position through mobile eye tracking, which can evaluate visual attention and thereby enable the diagnosis of cognitive disorders such as ADHD by collecting and providing quantitative eye tracking data.

Other objects of the present invention will become clearer through the preferred embodiments described below.

According to one aspect of the present invention, there is provided a computer program stored on a non-transitory computer-readable medium for performing a method for estimating an on-screen gaze position through mobile eye tracking. The computer program is configured to cause a computer to perform the steps of: acquiring a first camera input image capturing a face of a user gazing at a screen of a mobile terminal on which content is being executed; generating a first eye-cropped image by cropping an eye region from the first camera input image; extracting a pupil from the first eye-cropped image and estimating a first relative position; and converting the first relative position into screen coordinates related to the screen using a screen coordinate reference value.

In one embodiment, the generating the first eye-cropped image may include applying an N landmark model that represents a facial shape with N landmarks to the first camera input image; and extracting twelve landmarks, six on each side corresponding to each eye region, to thereby extract the first eye-cropped image.

In one embodiment, the estimating the first relative position may include extracting the pupil, distinguished from the sclera, by utilizing brightness differences in the first eye-cropped image; and converting the horizontal and vertical positions of the pupil into ratios within a possible movement region in which the pupil is allowed to move in the up, down, left, and right directions, thereby calculating the first relative position.

In one embodiment, a horizontal ratio (H-ratio) may be defined such that a rightmost position corresponds to 0 (zero), a leftmost position corresponds to 1, and a horizontal position between them can be represented by h, and a uppermost position corresponds to 0 (zero), a lowermost position corresponds to 1, and a vertical position between them can be represented by v, wherein the first relative position may be expressed as (h, v).

In one embodiment, the method may further include outputting a guide screen on the mobile terminal, on which a guide point having fixed coordinates is displayed; acquiring a second camera input image capturing the face of the user gazing at the guide screen; generating a second eye-cropped image by cropping an eye region from the second camera input image; extracting a pupil from the second eye-cropped image and estimating a second relative position; and setting the screen coordinate reference value by mapping the fixed coordinates and the second relative position.

In one embodiment, the guide point may be displayed in a designated sequence at upper-center, middle-left, middle-center, middle-right, and lower-center positions when the screen of the mobile terminal is divided into nine regions of {upper, middle, lower}×{left, center, right}.

According to another aspect of the present invention, there is provided a system for estimating an on-screen gaze position through mobile eye tracking, the system being installed on a mobile terminal and including: an image acquisition unit configured to acquire a first camera input image capturing a face of a user gazing at a screen of the mobile terminal on which content is being executed; an image processing unit configured to generate a first eye-cropped image by cropping an eye region from the first camera input image; a pupil position estimation unit configured to extract a pupil from the first eye-cropped image and estimate a first relative position; and a screen coordinate conversion unit configured to convert the first relative position into screen coordinates related to the screen using a screen coordinate reference value.

In one embodiment, a guide screen in which a guide point having fixed coordinates is displayed may be output on the mobile terminal, and the image acquisition unit may be configured to acquire a second camera input image capturing the face of the user gazing at the guide screen. The image processing unit may be configured to generate a second eye-cropped image by cropping an eye region from the second camera input image, the pupil position estimation unit may be configured to extract a pupil from the second eye-cropped image and estimate a second relative position, and the screen coordinate conversion unit may be configured to set the screen coordinate reference value by mapping the fixed coordinates and the second relative position.

Other aspects, features, and advantages other than those described above will become clear from the following drawings, claims, and detailed description of the invention.

According to one embodiment of the present invention, it is advantageous to extract eyes from an image of a user's face captured using a camera of a mobile terminal and estimate the on-screen gaze position viewed by the user from the movement of the pupils.

In addition, it is also advantageous to evaluate visual attention and thereby the diagnosis of cognitive disorders such as ADHD by collecting and providing quantitative eye tracking data.

The effects obtainable from the present invention are not limited to the effects mentioned above, and other unmentioned effects will be clearly understood by those with ordinary skill in the art to which the present invention pertains from the description below.

### BRIEF DESCRIPTION OF THE DRAWINGS

FIG. 1 illustrates a system for estimating an on-screen gaze position through mobile eye tracking according to one embodiment of the present invention;

FIG. 2 is a flowchart showing a method for setting a screen coordinate reference value in a method for estimating an on-screen gaze position through mobile eye tracking according to an embodiment of the present invention;

FIG. 3 is a flowchart showing a method for estimating an on-screen gaze position through mobile eye tracking according to one embodiment of the present invention;

FIG. 4 is an exemplary view of a camera input image;

FIG. 5 is an exemplary view of an eye-cropped image;

FIG. 6 is an exemplary diagram of landmark setting for processing a camera input image;

FIG. 7 is an exemplary diagram for deriving a relative position of a pupil;

FIG. 8 is a graph showing a ratio relationship of the relative position of the pupil;

FIG. 9 is an exemplary diagram of setting a screen coordinate reference value;

FIG. 10 is a diagram showing a screen coordinate conversion method; and

FIG. 11 illustrates a configuration of a system according to one embodiment of the present invention.

### DETAILED DESCRIPTION

As the present invention can be variously modified and have various embodiments, specific embodiments will be illustrated in the drawings and described in detail. However, this is not intended to limit the present invention to a specific embodiment, and it should be understood to include all modifications, equivalents, and substitutes included in the spirit and technical scope of the present invention.

When an element is referred to as being “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

Terms such as first, second, etc., may be used to refer to various elements, but, these element should not be limited due to these terms. These terms will be used to distinguish one element from another element.

The terms used in this specification are intended to merely describe specific embodiments, but not intended to limit the invention. A singular expression includes a plural expression, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

In this disclosure, the term “unit” refers to a unit implemented by hardware, a unit implemented by software, or a unit implemented by a combination of both. A single unit may be realized using two or more hardware components, and conversely, two or more units may be realized by a single hardware component. In addition, the term “unit” is not meant to be limited to software or hardware, and the “unit” may be configured to reside on an addressable storage medium or may be configured to execute one or more processors. Thus, in one example, “˜unit” may include components, such as software components, object-oriented software components, class components, and task components, as well as processes, functions, properties, procedures, subroutines, segments of program code, drivers, firmware, microcode, circuits, data, databases, data structures, tables, arrays, and variables. The functionality provided within the components and “˜units” may be combined into fewer components and “˜units” or further separated into additional components and “˜subunits”. In addition, the components and “˜units” may be implemented to cause one or more CPUs in the device to execute.

In addition, elements of an embodiment described with reference to each drawing is not limitedly applied only to the corresponding embodiment, but may be implemented to be included in another embodiment within a scope in which the technical spirit of the present invention is maintained. Furthermore, even if particular descriptions are omitted, it is apparent that multiple embodiments may be integrated and re-implemented as a single embodiment.

In describing the present invention with reference to the accompanying drawings, identical or related reference numerals are assigned to identical components regardless of the drawing numbers, and redundant descriptions thereof will be omitted. In explaining the present invention, if detailed descriptions of related known technologies are deemed to unnecessarily obscure the gist of the invention, such detailed descriptions will be omitted.

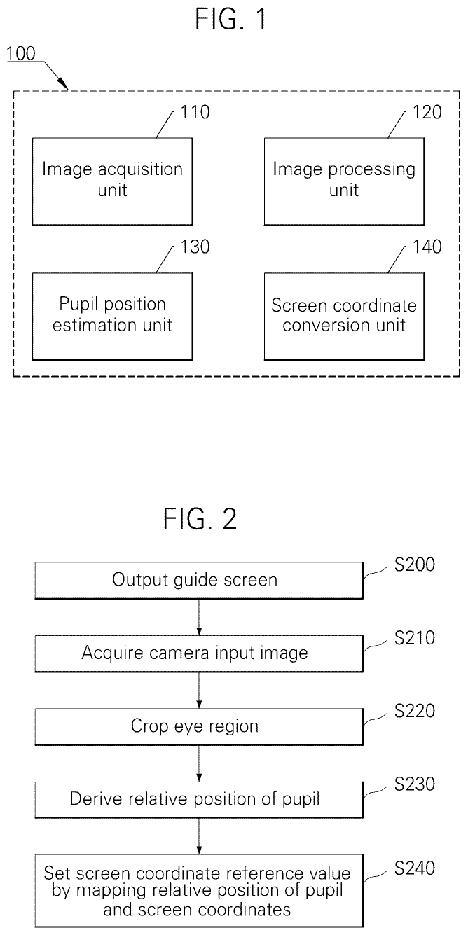

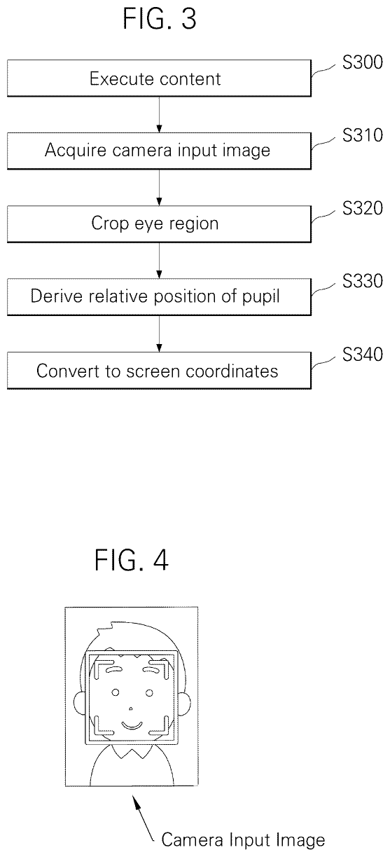

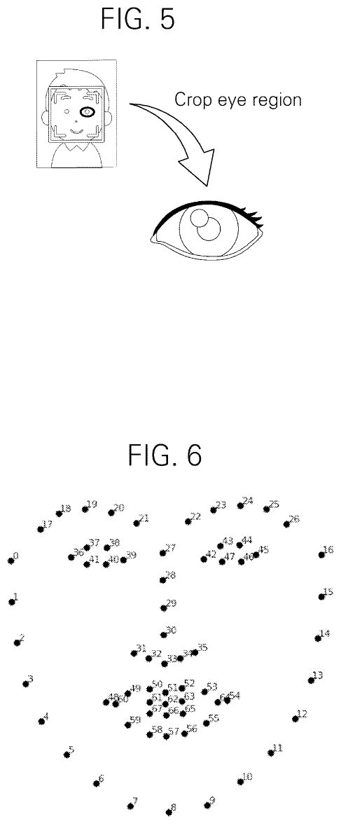

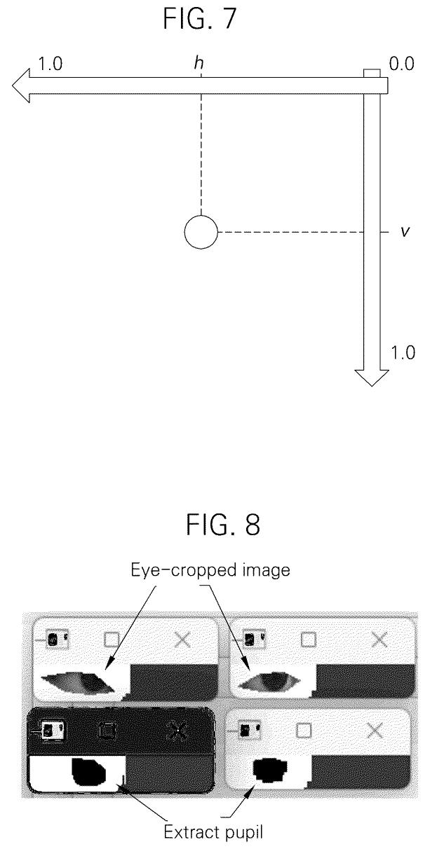

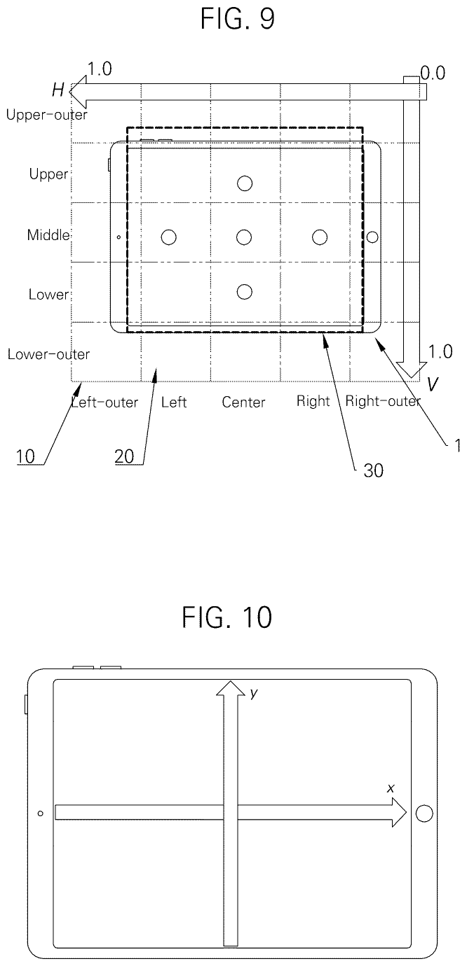

FIG. 1 illustrates a system for estimating an on-screen gaze position through mobile eye tracking according to one embodiment of the present invention, FIG. 2 is a flowchart showing a method for setting a screen coordinate reference value in a method for estimating an on-screen gaze position through mobile eye tracking according to an embodiment of the present invention, FIG. 3 is a flowchart showing a method for estimating an on-screen gaze position through mobile eye tracking according to one embodiment of the present invention, FIG. 4 is an exemplary view of a camera input image, FIG. 5 is an exemplary view of an eye-cropped image, FIG. 6 is an exemplary diagram of landmark setting for processing a camera input image, FIG. 7 is an exemplary diagram for deriving a relative position of a pupil, FIG. 8 is a graph showing a ratio relationship of the relative position of the pupil, FIG. 9 is an exemplary diagram of setting a screen coordinate reference value, and FIG. 10 is a diagram showing a screen coordinate conversion method.

A system and method for estimating an on-screen gaze position through mobile eye tracking according to one embodiment of the present invention is characterized by extracting eyes from an image of a user's face captured using a camera of a mobile terminal and estimating the on-screen gaze position viewed by the user based on the movement of the pupils.

An on-screen gaze position estimation system 100 through mobile eye tracking according to the present embodiment may be implemented as an application installed on a mobile terminal.

The mobile terminal on which the on-screen gaze position estimation system 100 is installed may be equipped with an input unit (e.g., a touchscreen, keypad, keyboard, mouse, microphone) for receiving user input, an output unit (e.g., a display, touchscreen) for displaying various information, a communication unit (e.g., a mobile communication module (3G, 4G, 5G), a short-range communication module (WiFi, Bluetooth)) for communication, a camera for capturing images, and the like.

In the present embodiment, the mobile terminal on which the on-screen gaze position estimation system 100 is installed may output an execution screen of content for attention evaluation through the output unit. In addition, the mobile terminal may also output a guide screen for setting a reference value for the conversion of screen coordinates.

Referring to FIG. 1, the on-screen gaze position estimation system 100 may include an image acquisition unit 110, an image processing unit 120, a pupil position estimation unit 130, and a screen coordinate conversion unit 140.

The image acquisition unit 110 may be configured to acquire a camera input image of user's face, which is gazing at the screen output through the output unit of the mobile terminal, from the camera. The camera is installed on the front side of the mobile terminal such that its field of view is directed toward the face of the user gazing at the screen of the mobile terminal, thereby enabling the capture of images related to the user's face.

An example of the camera input image is illustrated in FIG. 4. The magnification of the camera may be adjusted such that a facial region including the user's eyes, nose, mouth, and facial contour is acquired as the camera input image.

The image processing unit 120 may be configured to perform a designated image processing on the camera input image acquired by the image acquisition unit 110 to generate an eye-cropped image by retaining only the region corresponding to the eye and removing the remaining region (see FIG. 5).

An N-point landmark model may be applied to the camera input image to represent the user's face with N facial landmarks, and the eye-cropped image may be generated by focusing on the landmarks corresponding to the eyes.

As illustrated in FIG. 6, N may be 68, and the shape of the face may be represented by 68 facial landmarks. For example, each of the left and right eyes may be represented in a hexagonal shape with six landmarks respectively (36-41, 42-47).

The pupil position estimation unit 130 may be configured to extract the pupils from the eye-cropped image and estimate the relative position of the pupils by converting the horizontal and vertical positions of the pupils into ratios within a possible movement region in which the pupil is allowed to move in the up, down, left, and right directions. Accordingly, the ratios of the left and right eyes may be averaged to calculate the relative pupil position at that point in time.

Referring to FIG. 8, the eye-cropped image composed of a pair of hexagons corresponding to each eye region among the 68 landmarks is illustrated. In the eye-cropped image, the pupils can be distinguished based on brightness differences. The pupils have a dark color, whereas the surrounding sclera has a bright color. Therefore, the pupils may be extracted from the eye-cropped image by utilizing such brightness differences.

Once the pupil is extracted, its relative position (horizontal and vertical) within the eye region may be converted into a ratio.

Referring to FIG. 9, such relative position of the pupil can be calculated as a result of GazeTracking. The relative position may be constituted by two values as follows.

The horizontal ratio (H-ratio) may be defined such that the rightmost position corresponds to 0 (zero), the leftmost position corresponds to 1, and a horizontal position between them can be represented by h.

The vertical ratio (V-ratio) may be defined such that the uppermost position corresponds to 0 (zero), the lowermost position corresponds to 1, and a vertical position between them can be represented by v.

Accordingly, the relative position of the pupil may be expressed as (h, v).

The screen coordinate conversion unit 140 may be configured to convert the relative position of the pupil estimated by the pupil position estimation unit 130 into screen coordinates of the mobile terminal.

For this purpose, it is necessary to set a reference value for mapping the relative position of the pupil to the screen coordinates.

Accordingly, prior to executing content for attention evaluation, a guide screen for setting the reference value may be displayed on the terminal screen to allow the setting of a screen coordinate reference value regarding the user's pupil movement.

Referring to FIG. 9, an example of the guide screen that serves as a reference for screen coordinate conversion is shown.

Assuming a large region 10 in which the user's gaze may be located, including a screen 1 of the mobile terminal. The large region 10 may be partitioned into a total of twenty-five sub-regions 20, arranged in five sub-regions horizontally and five sub-regions vertically. In this case, the screen 1 of the mobile terminal may be disposed to correspond to nine central sub-regions 30.

In this case, guide points can be sequentially displayed for certain sub-regions 30 corresponding to the mobile terminal screen 1, prompting the user to focus their gaze. The guide points are predetermined coordinates on the screen to serve as a reference, and may have fixed screen coordinates.

In FIG. 9, although five guide points (upper-center, middle-left, middle-center, middle-right, and lower-center positions) are displayed, these guide points are not displayed simultaneously, but may be displayed one by one according to a predetermined sequence. When each guide point is displayed, the relative position of the pupil estimated by the pupil position estimation unit 130 becomes a screen coordinate reference value corresponding to the fixed coordinates of the respective guide point. This is a reference value (screen coordinate conversion reference) for subsequent coordinate conversion.

Accordingly, the fixed coordinates for each guide point may be mapped to the relative position of the pupil, making it possible to determine the characteristics of the user's pupil movement. Subsequently, in identifying the gaze of the user looking at a content execution screen, numerical values corresponding to the pupil movement may be compared with the screen coordinate conversion reference, so as to be converted into screen coordinates (x, y) (see FIG. 10).

In calculating the horizontal ratio and vertical ratio for the relative position of the pupil as described above, the region may be divided into twenty-five sub-regions ({upper-outer, upper, middle, lower, lower-outer}×{left-outer, left, center, right, right-outer}). Among these, nine central sub-regions ({upper, middle, lower}×{left, center, right}) may be determined as IN, while the remaining sub-regions may be determined as OUT.

Referring to FIG. 2, a method for setting a screen coordinate reference value in the system 100 according to the present embodiment is shown.

In S200, through the mobile terminal, the guide screen such as that illustrated in FIG. 9 may be displayed. The guide points may be sequentially displayed one by one according to the predetermined sequence.

In S210, the image acquisition unit 110 may be configured to acquire a camera input image of a user's face captured by a camera provided in the mobile terminal while the guide screen is being displayed.

In S220, the image processing unit 120 may be configured to perform a predetermined image processing on the camera input image to generate an eye-cropped image in which the eye region is cropped. During this process, an N-point landmark model may be applied.

In S230, the pupil position estimation unit 130 may be configured to extract a pupil from the eye-cropped image and estimate its relative position. The relative position of the pupil may be expressed as horizontal and vertical ratios.

In S240, the screen coordinate reference value may be set by mapping the relative position of the pupil to the screen coordinates corresponding to the guide point on the guide screen.

Referring to FIG. 3, a method for estimating an on-screen gaze position through mobile eye tracking after setting the screen coordinate reference value is shown.

In S300, content requiring gaze tracking of the user, such as visual-perceptual attention evaluation and cognitive ability training, is executed through the mobile terminal.

In S310, the image acquisition unit 110 may be configured to acquire a camera input image of a user's face captured by the camera provided in the mobile terminal while the content execution screen is being output.

In S320, the image processing unit 120 may be configured to perform a predetermined image processing on the camera input image to generate an eye-cropped image in which the eye region is cropped. During this process, the N-point landmark model may be applied.

In S330, the pupil position estimation unit 130 may be configured to extract a pupil from the eye-cropped image and estimate its relative position. The relative position of the pupil may be expressed as horizontal and vertical ratios.

In S340, using the previously established screen coordinate reference value, the relative position of the pupil obtained in Step S330 is converted into the corresponding screen coordinates.

By analyzing the converted screen coordinates, it can be determined whether the current gaze of the user is within the screen of the mobile terminal or outside the screen. In addition, when the gaze is within the screen, the specific position being gazed at may be precisely identified, thereby enabling determination as to whether the instructions during the content execution process are being properly performed.

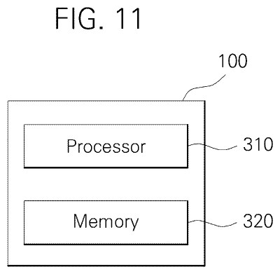

FIG. 11 illustrates a configuration of a system according to one embodiment of the present invention.

Referring to FIG. 11, the system 100 includes a processor 310 and a memory 320. The memory 320 stores one or more instructions executable by the processor 310. The processor 310 executes one or more instructions stored in the memory 320. The processor 310 can execute one or more operations by executing the instructions. In addition, the configuration of the present invention described above with reference to FIG. 1 may be a configuration implemented by instructions executed by the processor 310.

The embodiments described above can be implemented as hardware components, software components, and/or a combination of hardware and software components. For example, the devices, methods, and elements described in the embodiments can be implemented using one or more general-purpose computers or special-purpose computers, such as a processor, a controller, a Central Processing Unit (CPU), a Graphics Processing Unit (GPU), an arithmetic logic unit (ALU), a digital signal processor, a microcomputer, a field programmable gate array (FPGA), a programmable logic unit (PLU), a microprocessor, an Application Specific Integrated Circuit (ASICS), or any other device that can execute and respond to instructions.

The aforementioned method for estimating an on-screen gaze position can also be implemented in the form of a recording medium including computer-executable instructions, such as an application or program module executed by a computer. A computer-readable medium may be any available medium that can be accessed by a computer, and includes both volatile and non-volatile media, and both removable and non-removable media. In addition, the computer-readable medium may include a computer storage medium. A computer storage medium includes both volatile and non-volatile, removable and non-removable media implemented by any method or technology for storing information, such as computer-readable instructions, data structures, program modules, or other data.

The aforementioned method for estimating an on-screen gaze position can be executed by an application (which may include a program included in a platform or operating system mounted on the terminal by default) installed on the terminal by default, and can also be executed by an application (i.e., a program) installed directly on the master terminal by the user through an application store server or an application providing server such as a web server related to the application or the service. In this sense, the aforementioned method for estimating an on-screen gaze position is implemented as an application (i.e., a program) installed on the terminal by default or installed directly by the user, and can be recorded on a computer-readable recording medium such as a terminal.

Although the embodiments of the present invention have been described with reference to the drawings, those skilled in the art will understand that various modifications and changes can be made to the present invention without departing from the spirit and scope of the present invention as described in the following claims.

What is claimed is:

1. A computer program stored on a non-transitory computer-readable medium for performing a method for estimating an on-screen gaze position through mobile eye tracking, wherein the computer program is configured to cause a computer to perform:
acquiring a first camera input image capturing a face of a user gazing at a screen of a mobile terminal on which content is being executed;
generating a first eye-cropped image by cropping an eye region from the first camera input image;
extracting a pupil from the first eye-cropped image and estimating a first relative position; and
converting the first relative position into screen coordinates related to the screen using a screen coordinate reference value.

2. The computer program of claim 1, wherein the generating the first eye-cropped image comprises:
applying an N landmark model that represents a facial shape with N landmarks to the first camera input image; and
extracting twelve landmarks, six on each side corresponding to each eye region, to thereby extract the first eye-cropped image.

3. The computer program of claim 2, wherein the estimating the first relative position comprises:
extracting the pupil, distinguished from the sclera, by utilizing brightness differences in the first eye-cropped image; and
converting the horizontal and vertical positions of the pupil into ratios within a possible movement region in which the pupil is allowed to move in the up, down, left, and right directions, thereby calculating the first relative position.

4. The computer program of claim 3, wherein a horizontal ratio (H-ratio) is defined such that a rightmost position corresponds to 0 (zero), a leftmost position corresponds to 1, and a horizontal position between them can be represented by h, and a uppermost position corresponds to 0 (zero), a lowermost position corresponds to 1, and a vertical position between them can be represented by v, wherein the first relative position is expressed as (h, v).

5. The computer program of claim 1, wherein the method further comprises:
outputting a guide screen on the mobile terminal, on which a guide point having fixed coordinates is displayed;
acquiring a second camera input image capturing the face of the user gazing at the guide screen;
generating a second eye-cropped image by cropping an eye region from the second camera input image;
extracting a pupil from the second eye-cropped image and estimating a second relative position; and
setting the screen coordinate reference value by mapping the fixed coordinates and the second relative position.

6. The computer program of claim 5, wherein the guide point is displayed in a designated sequence at upper-center, middle-left, middle-center, middle-right, and lower-center positions when the screen of the mobile terminal is divided into nine regions of {upper, middle, lower}×{left, center, right}.

7. A system for estimating an on-screen gaze position through mobile eye tracking, the system being installed on a mobile terminal and comprising:
an image acquisition unit configured to acquire a first camera input image capturing a face of a user gazing at a screen of the mobile terminal on which content is being executed;
an image processing unit configured to generate a first eye-cropped image by cropping an eye region from the first camera input image;
a pupil position estimation unit configured to extract a pupil from the first eye-cropped image and estimate a first relative position; and
a screen coordinate conversion unit configured to convert the first relative position into screen coordinates related to the screen using a screen coordinate reference value.

8. The system of claim 7, wherein a guide screen in which a guide point having fixed coordinates is displayed is output on the mobile terminal, the image acquisition unit is configured to acquire a second camera input image capturing the face of the user gazing at the guide screen,
wherein the image processing unit is configured to generate a second eye-cropped image by cropping an eye region from the second camera input image, the pupil position estimation unit is configured to extract a pupil from the second eye-cropped image and estimate a second relative position, and the screen coordinate conversion unit is configured to set the screen coordinate reference value by mapping the fixed coordinates and the second relative position.
